(19) United States
(12) Patent Application Publication
(10) Pub. No.: US 2013/0225183 A1
(43) Pub. Date: Aug. 29, 2013

(54) METHODS AND APPARATUS FOR TURNING OFF MACRO CARRIERS TO DEPLOY FEMTOCELLS

(71) Applicant: QUALCOMM Incorporated, (US)

(72) Inventors: Farhad Meshkati, San Diego, CA (US); Mehmet Yavuz, San Diego, CA (US); Yeliz Tokgoz, San Diego, CA (US); Peerapol Tinnakornsrisuphap, San Diego, CA (US)

(73) Assignee: QUALCOMM Incorporated, San Diego, CA (US)

(21) Appl. No.: 13/771,906

(22) Filed: Feb. 20, 2013

Related U.S. Application Data
(60) Provisional application No. 61/603,154, filed on Feb. 24, 2012.

(51) Int. Cl. H04W 52/18

(52) U.S. Cl. CPC H04W 52/18
USPC 455/448

(57) ABSTRACT

Methods and apparatus are disclosed for deploying at least one small-coverage base station in a coverage area. The method includes configuring the at least one small-coverage base station to operate on a given channel. The method includes detecting usage information of the at least one small-coverage base station on the given channel. The method includes adjusting an overall transmit power of at least one large-coverage base station in the coverage area based at least in part on the usage information.

### CROSS-REFERENCE TO RELATED APPLICATION

The present application for patent claims priority to Provisional Application No. 61/603,154, filed Feb. 24, 2012, entitled “METHOD AND APPARATUS FOR TURNING OFF MACRO CARRIERS TO DEPLOY FEMTOCELLS”, which is assigned to the assignee hereof, and is hereby expressly incorporated in its entirety by reference herein.

### FIELD

The present disclosure relates generally to communication systems, and more specifically to techniques for deploying small-coverage base stations (e.g., femtocells).

### BACKGROUND

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of mobile entities, such as, for example, user equipments (UEs). A UE may communicate with a base station via the downlink (DL) and uplink (UL). The DL (or forward link) refers to the communication link from the base station to the UE, and the UL (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macro cellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, and small-coverage base stations (e.g., picocells and femtocells).

The Femto Forum, a non-profit membership organization focused on standardization and promotion of femtocell solutions, defines femto access points (FAPs), also referred to as femtocell units or femto nodes, to be low-powered wireless access points that operate in licensed spectrum and are controlled by the network operator, can be connected with existing handsets, and use a residential digital subscriber line (DSL) or cable connection for backhaul. In various standards or contexts, a FAP may be referred to as a home node B (HNB), home e-node B (HeNB), access point base station, etc. With the increasing popularity of FAPs, there is a desire to optimize bandwidth and resource allocation.

### SUMMARY

Methods and apparatus for deploying small-coverage base stations are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method operable by a network entity is disclosed for deploying at least one small-coverage base station in a coverage area. The method includes configuring the at least one small-coverage base station to operate on a given channel. The method includes detecting usage information of the at least one small-coverage base station on the given channel. The method includes adjusting an overall transmit power of at least one large-coverage base station in the coverage area based at least in part on the usage information.

In another aspect, an apparatus includes at least one processor configured to: configure at least one small-coverage base station to operate on a given channel; detect usage information of the at least one small-coverage base station on the given channel; and adjust an overall transmit power of at least one large-coverage base station in the coverage area based at least in part on the usage information. The apparatus includes a memory coupled to the at least one processor for storing data.

In another aspect, an apparatus for deploying at least one small-coverage base station in a coverage area includes means for configuring the at least one small-coverage base station to operate on a given channel. The apparatus includes means for detecting usage information of the at least one small-coverage base station on the given channel. The apparatus includes means for adjusting a transmit power of at least one large-coverage base station in the coverage area based at least in part on the usage information.

In another aspect a computer program product includes a computer-readable medium including code for causing a computer to configure at least one small-coverage base station in a coverage area to operate on a given channel, detect usage information of the at least one small-coverage base station on the given channel, and adjust a transmit power of at least one large-coverage base station in the coverage area based at least in part on the usage information.

In yet another aspect, a method operable by a network entity in a wireless network is disclosed. The method includes configuring at least one large-coverage base station to use time or frequency resources of the network. The method includes configuring at least one small-coverage base station to use a first subset of the time or frequency resources. The method includes, in response to a density of small-coverage base stations in a given coverage area increasing to a defined threshold level, configuring the at least one large-coverage base station to use a second subset of the time or frequency resources, wherein the second subset includes time or frequency resources that are orthogonal to the time or frequency resources in the first subset.

In another aspect, an apparatus in a wireless communication network includes at least one processor configured to: configure at least one large-coverage base station to use time or frequency resources; configure at least one small-coverage base station to use a first subset of the time or frequency resources; and, in response to a density of small-coverage base stations in a given coverage area increasing to a defined threshold level, configure the at least one large-coverage base station to use a second subset of the time or frequency resources, wherein the second subset includes time or frequency resources that are orthogonal to the time or frequency resources in the first subset. The apparatus includes a memory coupled to the at least one processor for storing data.

In another aspect, an apparatus in a wireless communication network includes means for configuring at least one large-coverage base station to use time or frequency resources. The apparatus includes means for configuring at least one small-coverage base station to use a first subset of the time or frequency resources. The apparatus includes means for configuring the at least one large-coverage base station to use a second subset of the time or frequency resources in response to a density of small-coverage base stations in a given coverage area increasing to a defined threshold level, wherein the second subset includes time or frequency resources that are orthogonal to the time or frequency resources in the first subset.

In another aspect, a computer program product includes a computer-readable medium comprising code for causing at least one computer to: configure at least one large-coverage base station to use time or frequency resources of the network; configure at least one small-coverage base station to use a first subset of the time or frequency resources; and in response to a density of small-coverage base stations in a given coverage area increasing to a defined threshold level, configure the at least one large-coverage base station to use a second subset of the time or frequency resources, wherein the second subset includes time or frequency resources that are orthogonal to time or frequency resources in the first subset.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE.

FIG. 4 is a block diagram illustrating another example communication system.

FIG. 5 is a simplified block diagram of several sample aspects of a communication system.

FIGS. 6A-B illustrate FAP deployment scenarios with different densities of FAPs.

FIG. 7 illustrates an exemplary process diagram for adjusting transmission power of a macro access point.

FIG. 8 illustrates an exemplary process diagram for configuring time or frequency resources of macro access points based on FAP density.

FIG. 9 illustrates aspects of a methodology for adjusting transmission power of a macro access point.

FIG. 10 illustrates other aspects of the methodology for adjusting transmission power of the macro access point.

FIG. 11 illustrates aspects of a methodology for configuring resource usage for a macro access point.

FIG. 12 shows an embodiment of an apparatus for adjusting transmission power and configuring resource usage, in accordance with the methodologies of FIGS. 9-11.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal or device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), home Node B (HNB) or home evolved Node B (HeNB), collectively referred to as H(e)NB, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA, WiFi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

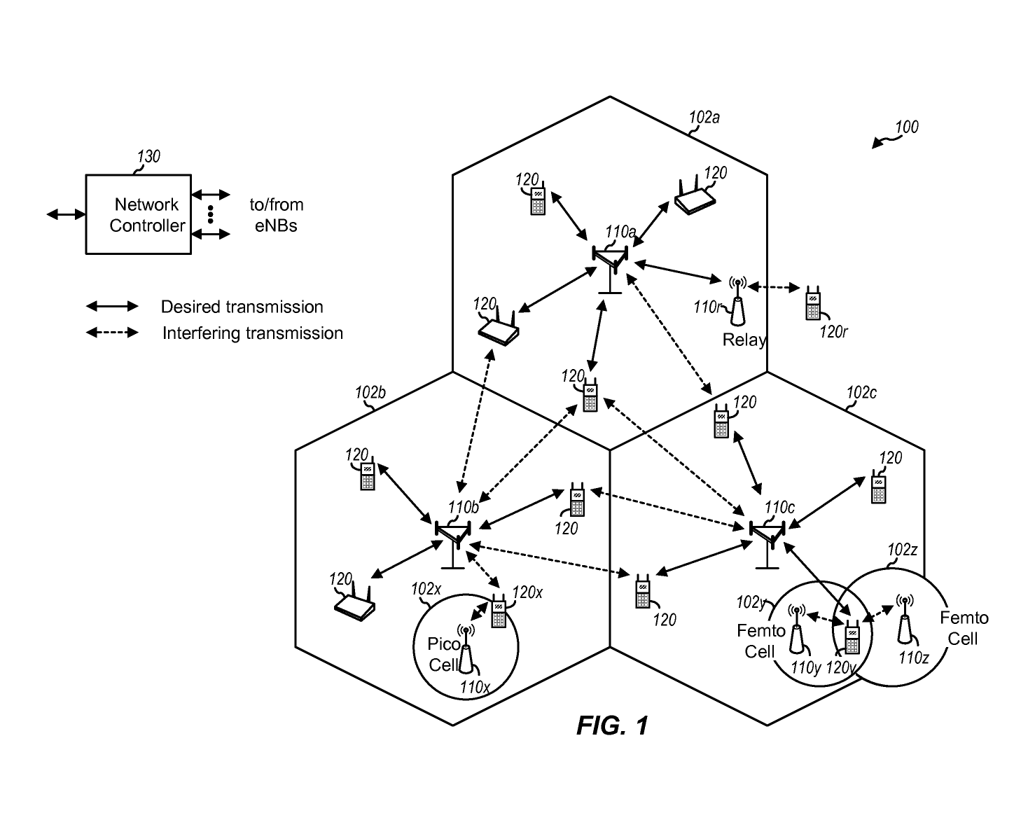

Referring now to FIG. 1, a wireless communication system 100, which may be an LTE network, is illustrated in accordance with various embodiments presented herein. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

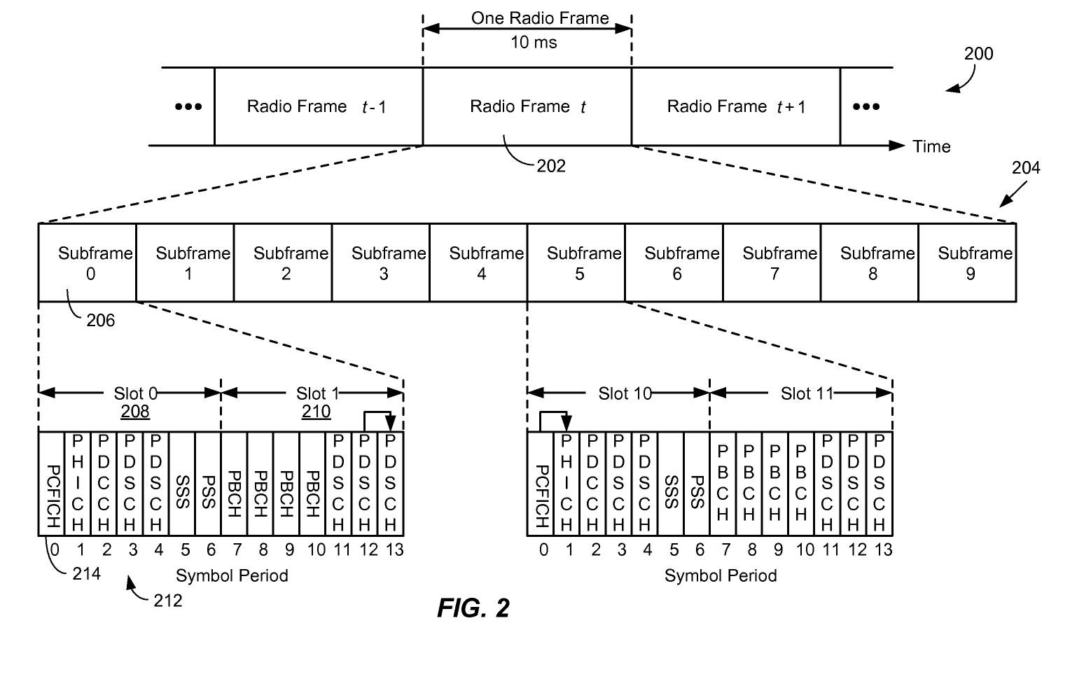

FIG. 2 shows a downlink frame structure 200 used in LTE. The transmission timeline for the downlink may be partitioned into units of radio frames 202, 204, 206. Each radio frame may have a predetermined duration (e.g., 10 milliseconds (ms)) and may be partitioned into 10 subframes 208 with indices of 0 through 9. Each subframe may include two slots, e.g., slots 210. Each radio frame may thus include 20 slots with indices of 0 through 19. Each slot may include L symbol periods, e.g., 7 symbol periods 212 for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH may also be included in the first symbol period. Similarly, the PHICH and PDCCH may also both be in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

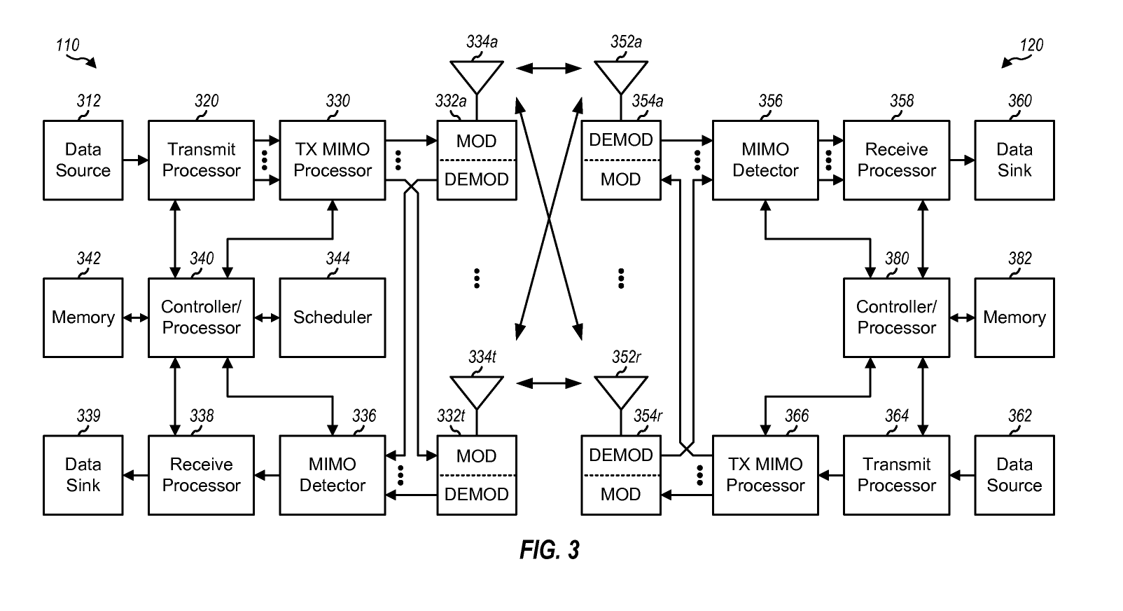

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type such as an access point including a femtocell, a picocell, etc. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

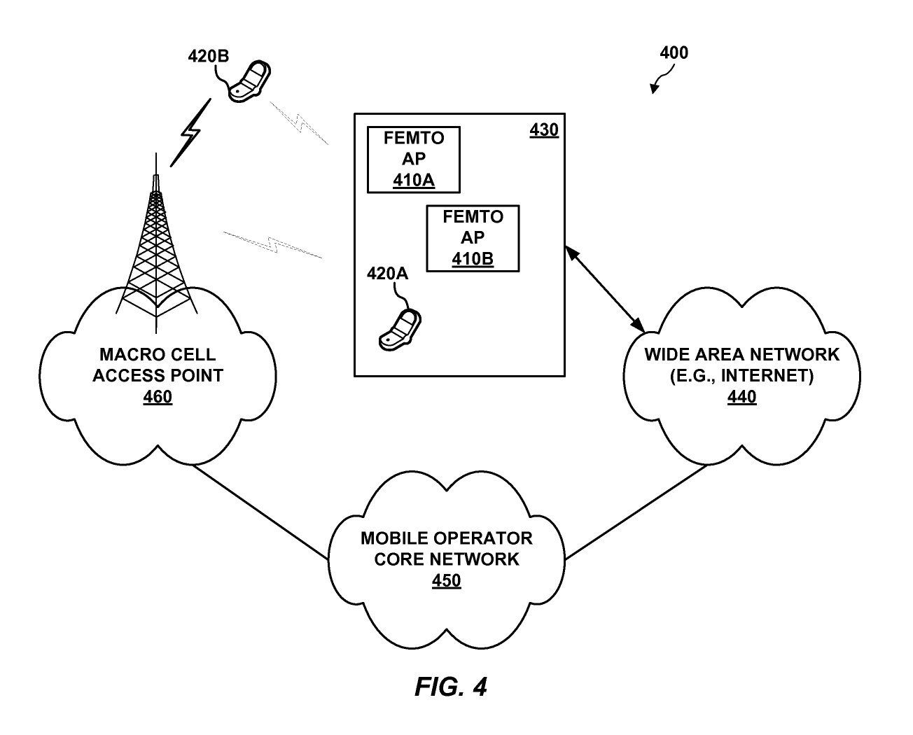

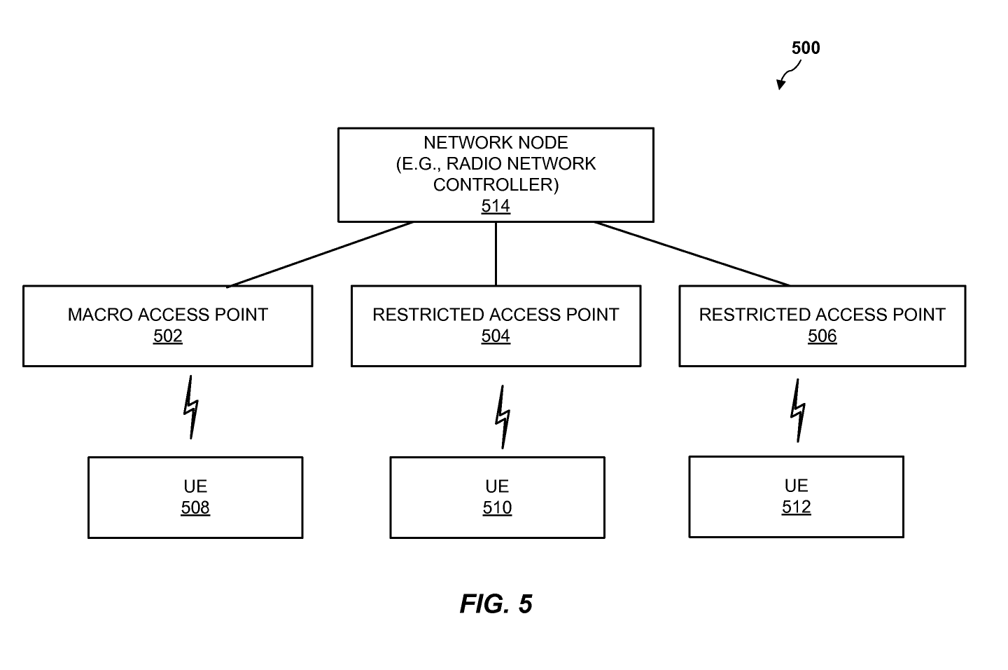

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

FIG. 4 illustrates an exemplary communication system 400 where one or more FAPs are deployed within a network environment. Specifically, the system 400 includes multiple FAPs 410A and 410B (e.g., FAPs or H(e)NB) installed in a relatively small scale network environment (e.g., in one or more user residences 430). Each FAP 410 can be coupled to a wide area network 440 (e.g., the Internet) and a mobile operator core network 450 via a digital subscriber line (DSL) router, a cable modem, a wireless link, or other connectivity means (not shown). As will be discussed below, each FAP 410 can be configured to serve associated access terminals 420 (e.g., access terminal 420A) and, optionally, alien access terminals 420 (e.g., access terminal 420B). In other words, access to FAPs 410 can be restricted such that a given access terminal 420 can be served by a set of designated (e.g., home) FAP(s) 410 but may not be served by any non-designated FAPs 410 (e.g., a neighbor's FAP).

FIG. 5 illustrates sample aspects of a communication system 500 where distributed nodes (e.g., access points 502, 504, and 506) provide wireless connectivity for other nodes (e.g., UEs 508, 510, and 512) that may be installed in or that may roam throughout an associated geographical area. In some aspects, the access points 502, 504, and 506 may communicate with one or more network nodes (e.g., a centralized network controller such as network node 514) to facilitate WAN connectivity.

An access point, such as access point 504, may be restricted whereby only certain mobile entities (e.g., UE 510) are allowed to access the access point, or the access point may be restricted in some other manner. In such a case, a restricted access point and/or its associated mobile entities (e.g., UE 510) may interfere with other nodes in the system 500 such as, for example, an unrestricted access point (e.g., macro access point 502), its associated mobile entities (e.g., UE 508), another restricted access point (e.g., access point 506), or its associated mobile entities (e.g., UE 512). For example, the closest access point to a given UE may not be the serving access point for the given UE. Consequently, transmissions by the given UE may interfere with reception at another UE that is being served by the access point that is closed to the given UE. Frequency reuse, frequency selective transmission, interference cancellation and smart antenna (e.g., beamforming and null steering) and other techniques may be employed to mitigate interference.

Referring again to FIG. 4, the owner of a FAP 410 can subscribe to mobile service, such as, for example, 3G mobile service, offered through the mobile operator core network 450. In another example, the FAP 410 can be operated by the mobile operator core network 450 to expand coverage of the wireless network. In addition, an access terminal 420 can be capable of operating both in macro environments and in smaller scale (e.g., residential) network environments. Thus, for example, depending on the current location of the access terminal 420, the access terminal 420 can be served by a macro access point 460 or by any one of a set of FAPs 410 (e.g., the FAPs 410A and 410B that reside within a corresponding user residence 430). For example, when a subscriber is outside his home, he is served by a standard macro access point (e.g., node 460) and when the subscriber is at home, he is served by a FAP (e.g., node 410A). Here, it should be appreciated that a FAP 410 can be backward compatible with existing access terminals 420.

A FAP 410 can be deployed on a single frequency or, in the alternative, on multiple frequencies. Depending on the particular configuration, the single frequency or one or more of the multiple frequencies can overlap with one or more frequencies used by a macro access point (e.g., node 460). In some aspects, an access terminal 420 can be configured to connect to a preferred FAP (e.g., the home FAP of the access terminal 420) whenever such connectivity is possible. For example, whenever the access terminal 420 is within the user's residence 430, it can communicate with the home FAP 410.

In some aspects, if the access terminal 420 operates within the mobile operator core network 450 but is not residing on its most preferred network (e.g., as defined in a preferred roaming list), the access terminal 420 can continue to search for the most preferred network (e.g., FAP 410) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 420 can limit the search for specific band and channel. For example, the search for the most preferred system can be repeated periodically. Upon discovery of a preferred FAP, such as FAP 410, the access terminal 420 selects the FAP 410 for camping within its coverage area.

A FAP can be restricted in some aspects. For example, a given FAP can only provide certain services to certain access terminals. In deployments with so-called restricted (or closed) association, a given access terminal can only be served by the macro cell mobile network and a defined set of FAPs (e.g., the FAPs 410 that reside within the corresponding user residence 430). In some implementations, a FAP can be restricted to not provide, for at least one access terminal, at least one of: signaling, data access, registration, paging, or service.

In some aspects, a restricted FAP (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., FAPs) that share a common access control list of access terminals. A channel on which all FAPs (or all restricted FAPs) in a region operate can be referred to as a femto channel.

Various relationships can thus exist between a given FAP and a given access terminal. For example, from the perspective of an access terminal, an open FAP can refer to a FAP with no restricted association. A restricted FAP can refer to a FAP that is restricted in some manner (e.g., restricted for association and/or registration). A home FAP can refer to a FAP on which the access terminal is authorized to access and operate on. A guest FAP can refer to a FAP on which an access terminal is temporarily authorized to access or operate on. An alien FAP can refer to a FAP on which the access terminal is not authorized to access or operate on, except for perhaps emergency situations (e.g., 911 calls).

From a restricted FAP perspective, a home access terminal can refer to an access terminal that authorized to access the restricted FAP. A guest access terminal can refer to an access terminal with temporary access to the restricted FAP. An alien access terminal can refer to an access terminal that does not have permission to access the restricted FAP, except for perhaps emergency situations, for example, 911 calls (e.g., an access terminal that does not have the credentials or permission to register with the restricted FAP).

For convenience, the disclosure herein describes various functionality in the context of a FAP. It should be appreciated, however, that a pico node can provide the same or similar functionality as a FAP, but for a larger coverage area. For example, a pico node can be restricted, a home pico node can be defined for a given access terminal, and so on.

In accordance with one or more embodiments of the present disclosure, there are provided techniques for determining to adjust the transmit power of a macrocell to allow for the deployment of femtocells on a dedicated carrier. The transmit power may include an entire transmission power at the macro access point 110d. The entire transmission power may include transmission power for any or all common channels, control channels, and data channels.

Bandwidth is scarce resource and may need to be allocated and managed efficiently. Capacity offload gains of a femtocell network are maximized when femtocells are deployed on a dedicated carrier—there are no interferences from macrocell networks on the same channel the femtocells are operating on. In this regard, it is desirable to reach a capacity of femtocells that may entirely serve an area so that the carrier may be turned off on a macrocell. It is not necessary for every section of the coverage area to be covered by a femtocell because those users not already served may deploy femtocells themselves and speed up adoption of the femtocell. Specifically, the power of a macrocell may be turned down or turned off entirely as the number of femtocells utilizing a particular carrier becomes great enough to maximize the network capacity. Femtocells may access the core network through additional data paths, e.g., through the Internet via various internet service providers, and provide additional bandwidth for communication with the core network. The decision to turn down or turn off the macrocell may be based on the density of femtocells deployed in a given geographic area. As the femtocell deployment density increases past a predefined threshold (e.g., a certain number or percentage of households in a given geographic area with installed femtocells), the network may determine to reduce the transmit power of macro access points utilizing the particular carrier in that given geographic area where femtocells are deployed. Additionally or alternatively, the network may determine to turn off the macro access points by gradually reducing, and eventually turning off, the transmit power of the macro access points. The determination to reduce the power or completely turn off the macro access point may also be based in part on network traffic, data demand, or a signaling load of the network, backhaul capacity of the femtocells and/or macrocell, or backhaul cost in the coverage area of the macrocell or picocell. For example, if the network traffic, data demand, or signaling load of the network meets or exceeds a predefined threshold, the network may turn down or turn off the macro access points to enable a greater offload to femtocells, and consequently, increase the network capacity to handle the data demand or signaling load.

In another aspect of the present disclosure, the network may begin reducing (or shutting down) the macro access points in a certain geographic area in an effort to expedite the deployment of femtocells by users or the network operator to increase the femtocell density and maximize the overall network capacity.

Once macro access points are turned down or turned off, the femtocells may be switched from “private” femtocells to “public” femtocells by changing the femtocell access mode from closed access mode to open or hybrid access mode. The network may increase the femto transmit power in addition to changing the femtocell access mode.

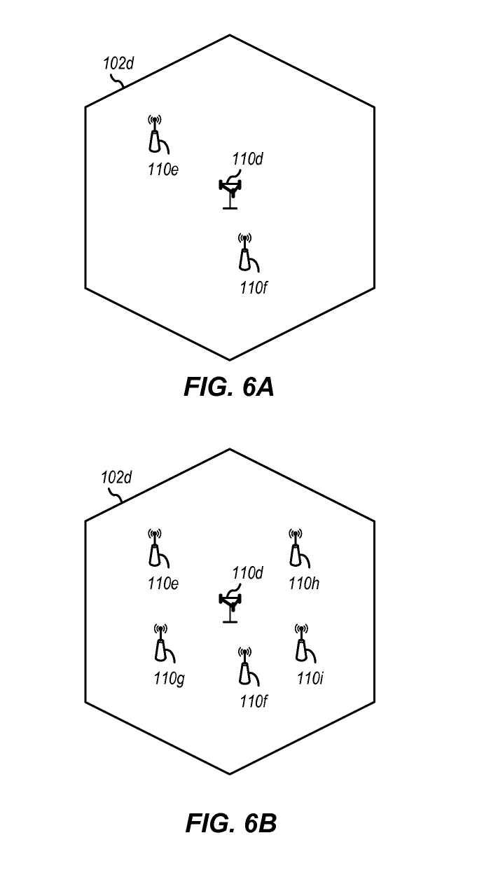

FIGS. 6A-B illustrate FAP deployment scenarios with increasing densities of FAPs. FIG. 6A illustrates FAP deployment with a sparse density of FAPs. A macro access point 110d provides service coverage area for wireless devices in a macrocell 102d. Femtocells 110e-f residing within the macrocell 102d may provide service for mobile devices within coverage areas of the FAPs 110e-f. The FAPs may be in communication with a core network entity such as a home node B (HNB) management system (HMS), an operation, administration, and management (OAM) system, or a centralized self-organizing network (SON) server.

The core network entity may configure the FAPs for initial or subsequent operation. Additional or alternatively, the FAPs may be pre-configured, configured by the user of the FAP, or by another network entity. For example, the core network entity may configure the FAPs with parameters and settings for the macrocell 102d coverage area. The FAPs may be configured to operate on a given set of frequency or time resources, and one or more given channels. A given channel may occupy a set of the time or frequency resources. The FAP may be configured to be in closed access mode for supporting a pre-defined set of wireless devices.

In the example of FIG. 6A, the density of the FAPs may be, e.g., one percent, when the FAPs are installed in one percent of households in the macrocell 102d coverage area. The network may be configured to adjust the macro access point power at a predefined threshold, e.g., two percent. The macrocell power may be reduced at a long-term time scale or permanently. For example, the time scale may be on the order of the lifetime of the macro access point 110d. The permanent macro access point 110d power reduction may encourage further femtocell deployment by users. Additionally or alternatively, when the density of FAPs drops below a threshold, the network may determine to increase the macro access point 110d transmission power.

When the density reaches another threshold, e.g., three percent of households, the network may turn off transmission for a carrier at the macro access point 110d. The macro access point may operate on one or more carriers, and one of more of the carriers may be turned off. The network may determine to turn off the entire transmission power at the macro access point 110d such that wireless transmissions cease entirely at the macro access point 110d. The entire transmission may include transmissions for any or all common channels, control channels, and data channels. The network may determine the density based on communications with the FAPs 110e-f or through indirect methods such as accounting and other information. Additionally or alternatively, the FAPs may send an indication in a message to the network. The density of femtocells may be based on additions or removal of femtocells. When a femtocell is added or removed, the network may store an indication of the addition or removal.

Returning to FIG. 6A, a number of femtocells 110e-f is located in the macrocell 102d coverage area. The network may learn of the number of FAPs through registrations of the FAPs 110e-f or via communication with the FAPs. The macro access point 110d may be operating normally at a given transmission power to serve the macrocell 102d coverage area. The network determines the density of the FAPs 110e-f in the macrocell 110d coverage area. In response to determining the density of the FAPs 110e-f is below a predefined density threshold (e.g., two percent), the network may refrain from adjusting the transmission power of the macro access point 110d.

In another example, the macro access point 110d transmission power may be reduced to encourage and speed up femtocell deployment. For example, the network may reduce the transmission power of the macro access point 110d even in the case of a determination that the density of FAPs is below the threshold, e.g., in the example of FIG. 6A.

FIG. 6B illustrates FAP deployment with an increased number of FAPs compared to FIG. 6A. FAPs 110g-i have been added to the macrocell 102d coverage area. The density of FAPs in the example of FIG. 6B may be two percent. The network detects the increased density and compares the density to a threshold. Upon determining the density, e.g., two percent, of the FAPs meeting a predefined threshold the network may determine to adjust the transmission power of the macro access point 110d. The network may reduce or completely turn off transmission power of the macro access point 110d. The network may reduce or completely turn off a carrier of the macro access point 110d. The carrier may be dedicated for use by the FAPs 110e-f. Additionally or alternatively, the network may reduce the power incrementally. For example, the network may reduce the transmission power of the macro access point 110d based on a set of thresholds, and turn off the transmission power of one or more carriers based on a last threshold of the set of thresholds.

In case the carrier is turned off or the entire transmission power of the macro access point 110d is turned off, the network may reconfigure one or more of the FAPs operating in closed access mode to open access mode or hybrid access mode. The open access mode or hybrid access mode may enable service to other wireless devices in the macrocell 102d coverage area, and achieve greater offloading gains. Once the carrier on the macrocell is turned off, potential interference between the macrocell and femtocells is reduced or eliminated. The carrier may be dedicated for use by the FAPs in the macrocell 102d coverage area. Additionally, the carrier may be turned off at adjacent or neighboring macro access points. Turning off the carrier at adjacent macro access points may further reduce the potential for interference on the carrier.

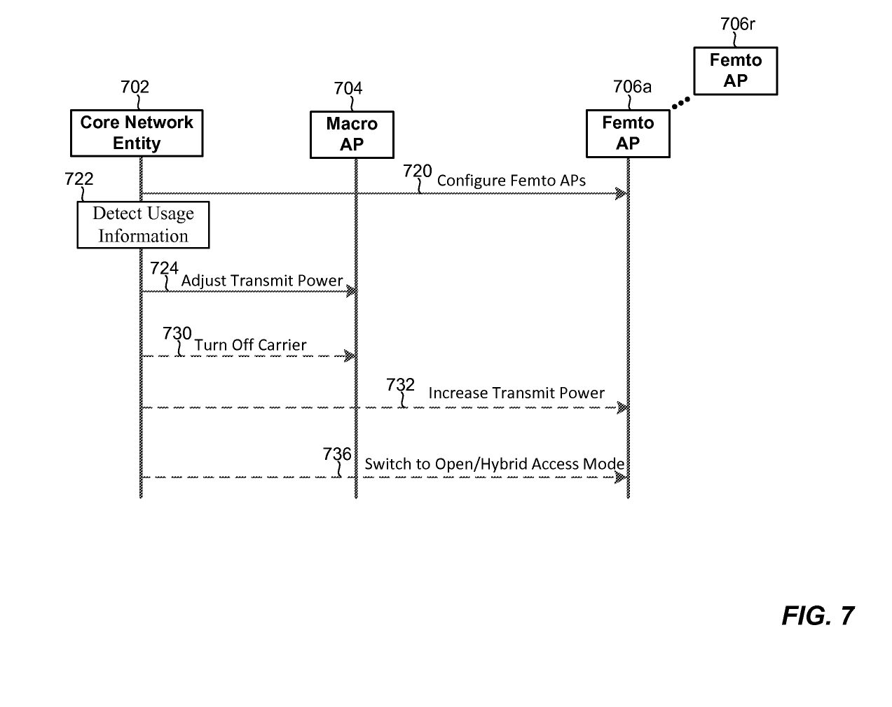

FIG. 7 illustrates an exemplary process diagram for adjusting transmission power of a macro access point. At 720, the network, e.g., at a core network entity 702, may configure one or more FAPs, e.g., FAPs 706a-706r, for operation. For example, the core network entity 702 may be an HMS, an OAM, or a SON system. Additionally or alternatively, the FAPs 706a-706r may be configured by other network entities, pre-configured during manufacturing, or by a user of the FAP. The core network entity 702 may configure the FAPs 706a-706r to operate on a given channel of the wireless system. The FAPs 706a-706r may be further configured by the user or other network entities. The given channel may occupy certain frequency or time resources. At 722, the core network entity 702 receives or otherwise obtains usage information of the FAPs 706a-706r. Based on usage information from the femtocells, the core network entity 702 may determine a density of the FAPs in the coverage area of a macro access point 704. The density may meet or exceed a density threshold. At step 724, based on determining the density of the FAPs meeting or exceeding the density threshold, the core network entity 702 may adjust transmission power of the macro access point 704. For example, core network entity 702 may turn down the transmission power at the macro access point 704. At 730, the core network entity 702 may optionally signal for the macro access point 704 to turn off a carrier or to completely turn off the transmission power at the macro access point 704. The transmission power adjustment may be a long term power adjustment.

After the carrier or entire transmission power of the macro access point 704 has been turned off, the core network entity 702 may optionally increase a transmission power of the FAPs at 732. The core network entity 702 may optionally switch the access mode of one or more FAPs from closed access mode to open access mode or hybrid access mode at 736. The increased transmission power from the FAPs may provide coverage for wireless devices in the macrocell coverage area. Open access mode or hybrid access mode FAPs may serve additional wireless devices that are in the area if the wireless devices were previously not allowed to access the FAPs in closed access mode.

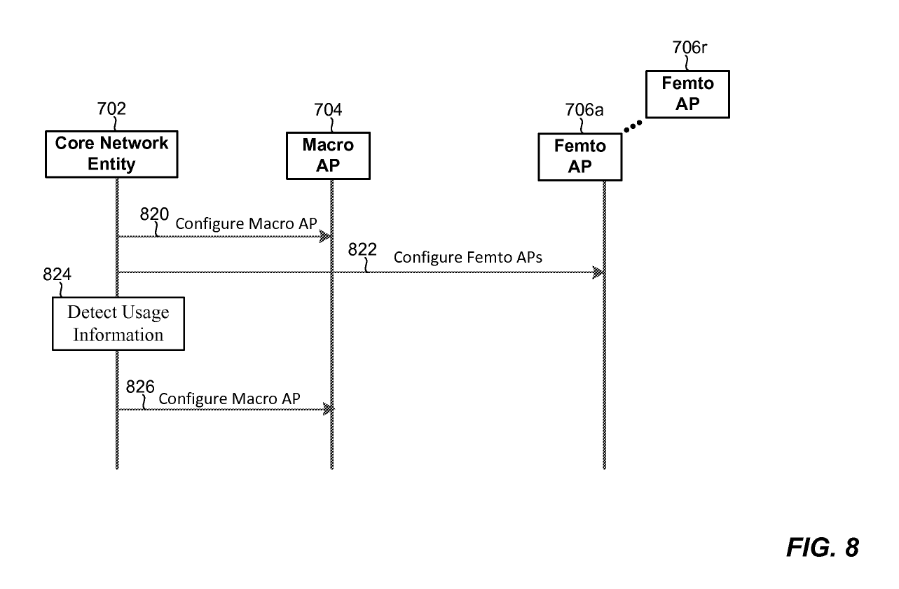

FIG. 8 illustrates an exemplary process diagram for configuring time or frequency resources of macro access points based on FAP density. The macro access point 704 and FAPs 706a-706r may be configured to use different resources. The macro access point 704 may use time or frequency resources that are orthogonal to the time or frequency resources used by the FAPs 706a-706r. The time or frequency resources may be partitioned into subsets of resources. The subsets may be orthogonal to each other. The FAPs 706a-706r may be configured to use a first subset. When it is determined that the density of femtocells in the macrocell coverage area meets or exceeds a threshold, the macrocell may be configured to use a second subset of the resources. The resources are selected to be orthogonal such that the frequencies or time do not interfere with each other. When there are few FAPs in area of a macro access point 704, the macro access point 704 may operate on the same time or frequency resources because the interference between the macro access point and FAPs may be limited. On the other hand, when the number or density of femtocells increase to or above a certain threshold, the benefit to sharing the time or frequency resources is diminished because the larger number of FAPs increases the interference with the macro access point.

At 820, the core network entity 702 may configure the macro access point 704 to use time or frequency resources of the wireless network. For example, the core network entity 702 may be an HMS, an OAM, or SON system. At 822, the core network entity 702 configures one or more FAPs 706a-706r for operation on a given channel. For example, the core network entity 702 may configure the FAPs 706a-706r to use a first subset of the time or frequency resources. At 824, the core network entity 702 may detect or obtain usage information for the FAPs 706a-706r. Based on the usage information, at 826, the core network entity 702 may configure the macro access point 704 to use different time or frequency resources. For example, the different time or frequency resources may be a second subset of resources that is orthogonal to the first subset of resources. The orthogonal frequency or time resource allocation allows the FAPs 706a-706r and macro access point 704 to avoid interference.

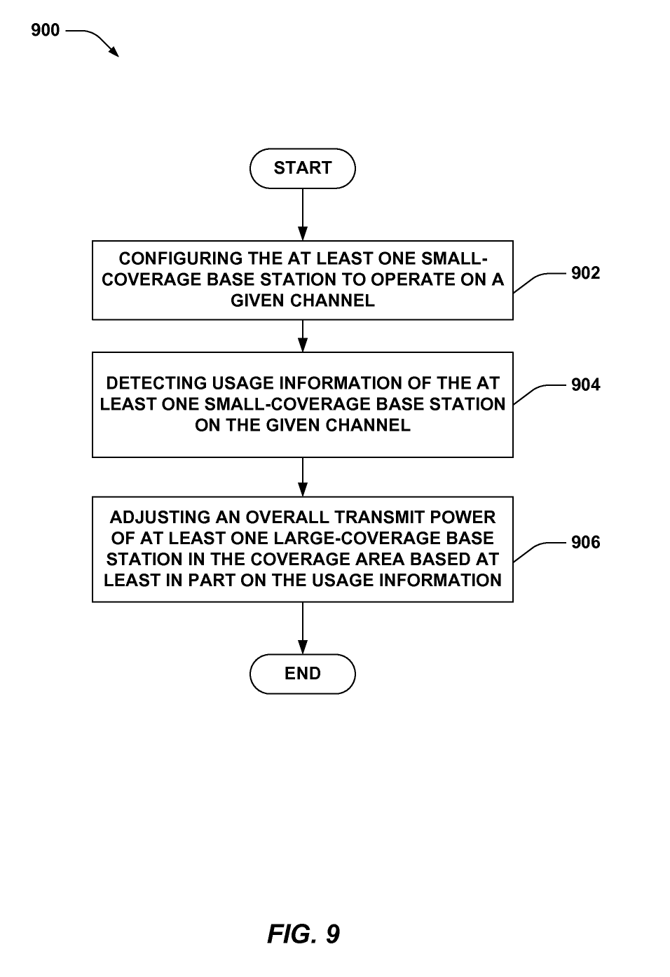

In accordance with one or more aspects of the embodiments described herein, with reference to FIG. 9, there is shown a methodology 900, operable by a network entity, such as, for example, an HMS, an OAM server, SON server, or the like. Specifically, method 900 describes a way to adjust power of a macro access point based on deployed small-coverage base stations (e.g., a femtocell or the like). The method 900 may involve, at 902, configuring the at least one small-coverage base station to operate on a given channel. The method 900 may involve, at 904, detecting usage information of the at least one small-coverage base station on the given channel. Further, the method may involve, at 906, adjusting a transmit power of at least one large-coverage base station (e.g., macrocell or picocell) in the coverage area based at least in part on the usage information. The usage information may refer to various information associated with the small-coverage base stations. For example, the usage information may refer to a density of deployed femtocells in the coverage area, a data demand of the network, a backhaul capacity of the coverage area, or the like.

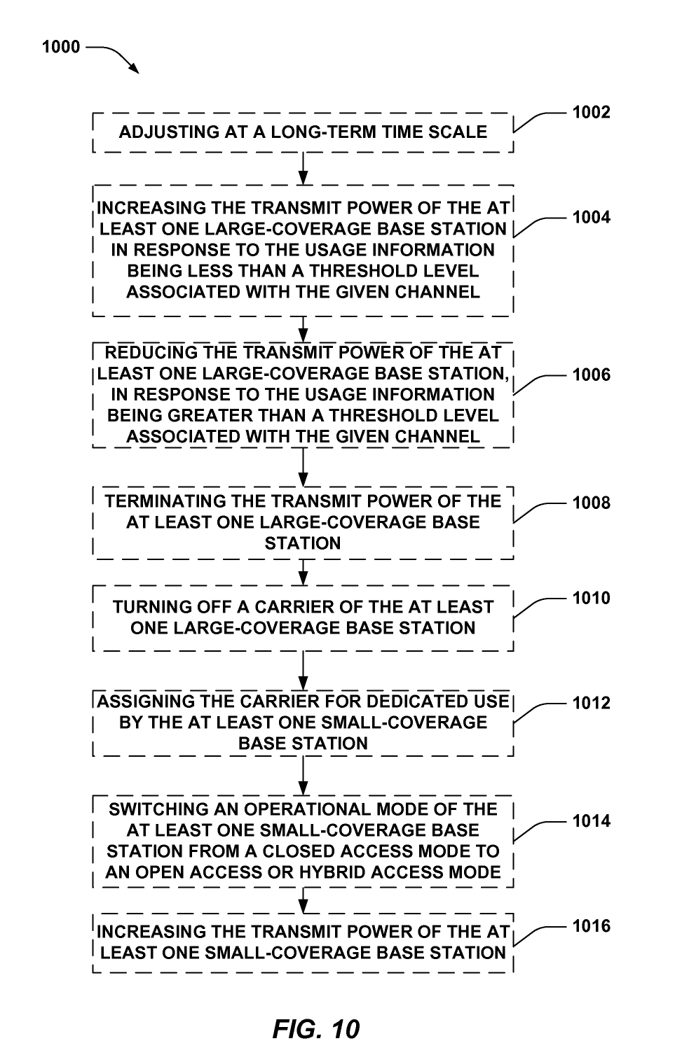

With reference to FIG. 10, there is shown further operations 1000 or aspects of the method 900 of FIG. 9 that are optional and may be performed by a network entity or the like. If the method 1000 includes at least one block of FIG. 10, then the method 1000 may terminate after the at least one block, without necessarily having to include any subsequent downstream block(s) that may be illustrated. It is further noted that numbers of the blocks do not imply a particular order in which the blocks may be performed according to the method 1000. For example, the method 1000 may further involve: adjusting at a long-term time scale (block 1002), increasing the transmit power of the at least one large-coverage base station in response to the usage information being less than a threshold level associated with the given channel (block 1004), and reducing the transmit power of the at least one large-coverage base station, in response to the usage information being greater than a threshold level associated with the given channel (block 1006), terminating the transmit power of the at least one large-coverage base station (block 1008), turning off a carrier of the at least one large-coverage base station (block 1010), assigning the carrier for dedicated use by the at least one small-coverage base station (block 1012), switching an operational mode of the at least one small-coverage base station from a closed access mode to an open access or hybrid access mode (block 1014), increasing the transmit power of the at least one small-coverage base station (block 1016).

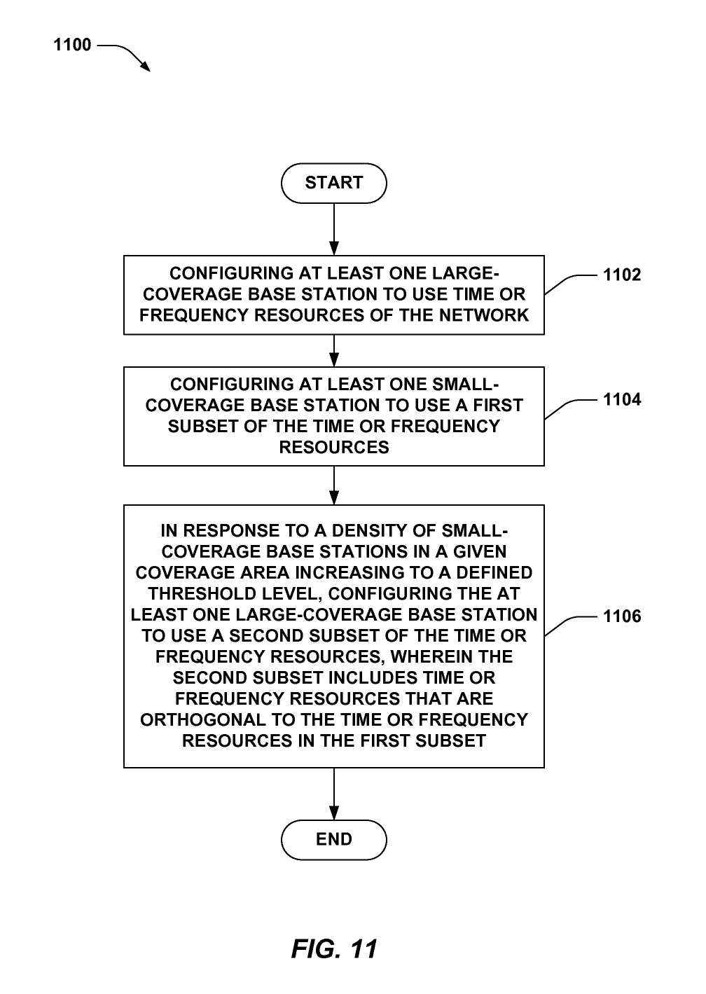

In accordance with one or more aspects of the embodiments described herein, with reference to FIG. 11, there is shown a methodology 1100, operable by a network entity, such as, for example, an HMS, an OAM server, or the like. Specifically, method 1100 describes a way to configure resource usage for large-coverage base station (e.g., macrocell, picocell, or the like). The method 1100 may involve, at 1102, configuring at least one large-coverage base station to use time or frequency resources of the network. The method 1100 may involve, at 1104, configuring at least one small-coverage base station to use a first subset of the time or frequency resources. The method 1100 may involve, at 1106, in response to a density of small-coverage base stations in a given coverage area increasing to a defined threshold level, configuring the at least one large-coverage base station to use a second subset of the time or frequency resources, wherein the second subset includes time or frequency resources that are orthogonal to the time or frequency resources in the first subset.

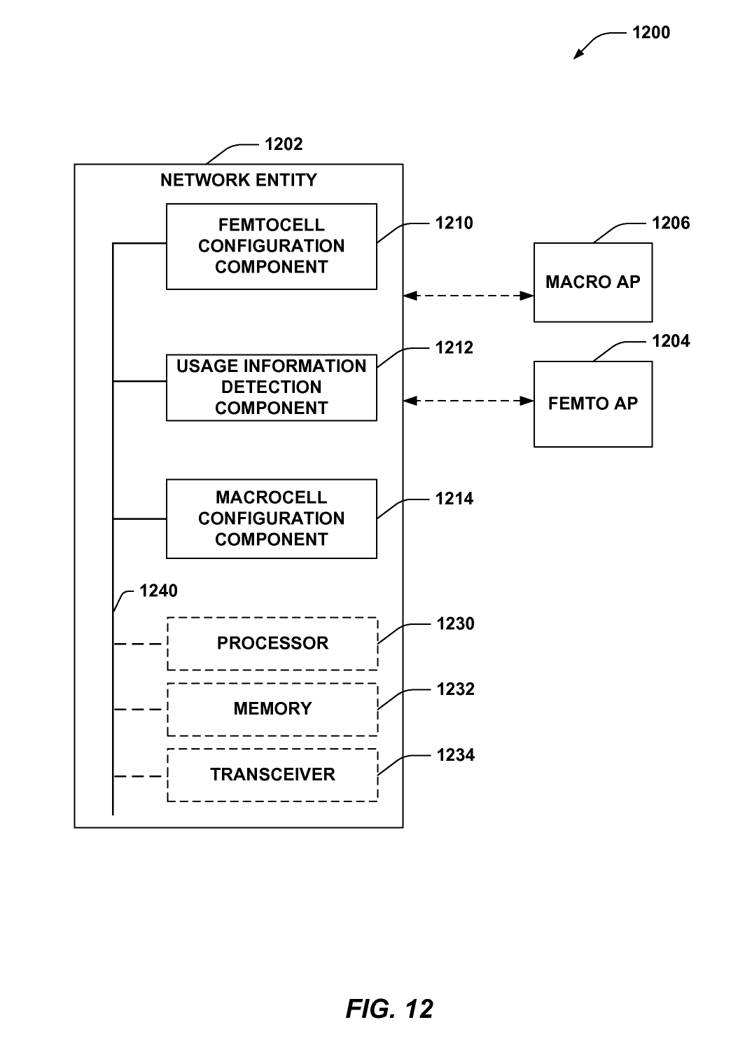

With reference to FIG. 12, there is provided an exemplary apparatus 1202 that may be configured as a network entity (e.g., an HMS, an OAM, or SON server) in a wireless system 1200, or as a processor or similar device/component for use within the apparatus. The apparatus 1202 may include functional blocks that can represent functions implemented by a processor, software, or combination thereof (e.g., firmware). For example, apparatus 1202 may include a femtocell configuration component 1210 for configuring at least one small-coverage base station to operate on a given channel. The femtocell configuration component 1210 may be, or may include, means for configuring at least one small-coverage base station to operate on a given channel. Said means may include an algorithm executed by one or more processors. The algorithm may include, for example, one or more of algorithms 902 described above in connection with FIG. 9.

The apparatus 1202 may include a usage information detection component 1212 for detecting usage information of the at least one small-coverage base station on the given channel. The usage information detection component 1212 may be, or may include, means for detecting usage information of the at least one small-coverage base station on the given channel. Said means may include an algorithm executed by one or more processors. The algorithm may include, for example, algorithm 904 described above in connection with FIG. 9.

The apparatus 1202 may include a macrocell configuration component 1214 for adjusting an overall transmit power of at least one large-coverage base station in the coverage area based at least in part on the usage information. The macrocell configuration component 1214 may be, or may include, means for adjusting an overall transmit power of at least one large-coverage base station in the coverage area based at least in part on the usage information. Said means may include an algorithm executed by one or more processors. The algorithm may include, for example, algorithm 906 described above in connection with FIG. 9.

In another aspect, the macrocell configuration component 1214 may be configured for configuring at least one large-coverage base station to use time or frequency resources of the network. The macrocell configuration component 1214 may be, or may include, means for configuring at least one large-coverage base station to use time or frequency resources of the network. Said means may include an algorithm executed by one or more processors. The algorithm may include, for example, one or more of algorithms 1102 described above in connection with FIG. 11.

The femtocell configuration component 1210 may be configured for configuring at least one small-coverage base station to use a first subset of the time or frequency resources. The femtocell configuration component 1210 may be, or may include, means for configuring at least one large-coverage base station to use time or frequency resources of the network. Said means may include an algorithm executed by one or more processors. The algorithm may include, for example, one or more of algorithms 1104 described above in connection with FIG. 11.

The macrocell configuration component 1214 may be configured for, in response to a density of small-coverage base stations in a given coverage area increasing to a defined threshold level, configuring the at least one large-coverage base station to use a second subset of the time or frequency resources, wherein the second subset includes time or frequency resources that are orthogonal to the time or frequency resources in the first subset. The macrocell configuration component 1214 may be, or may include, means for configuring the at least one large-coverage base station to use a second subset of the time or frequency resources in response to a density of small-coverage base stations in a given coverage area increasing to a defined threshold level, wherein the second subset includes time or frequency resources that are orthogonal to the time or frequency resources in the first subset. Said means may include an algorithm executed by one or more processors. The algorithm may include, for example, one or more of algorithms 1106 described above in connection with FIG. 11.

Additionally, the network entity 1202 can include a memory 1232 that retains instructions for executing functions associated with the components 1210-1214. While shown as being external to memory 1232, it is to be understood that one or more of the components 1210-1214 can exist within memory 1232. In one example, components 1210-1214 can comprise at least one processor, or each component 1210-1214 can be a corresponding module of at least one processor. Moreover, in an additional or alternative example, components 1210-1214 can be a computer program product comprising a computer readable medium, where each component 1210-1214 can be corresponding code.

In related aspects, the network entity 1202 can optionally include a processor component 1230 having at least one processor. The processor 1230, in such case, can be in operative communication with the components 1210-1214 via a bus 1240 or similar communication coupling. The processor 1230 can effect initiation and scheduling of the processes or functions performed by components 1210-1214.

In further related aspects, the network entity 1202 can include a radio transceiver component 1234. A stand-alone receiver and/or stand-alone transmitter can be used in lieu of or in conjunction with the transceiver component 1234. The network entity 1202 can also include a network interface (not shown) for connecting to one or more network entities, such as macro access point 1206 or FAP 1204.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method operable by a network entity for deploying at least one small-coverage base station in a coverage area, the method comprising:
configuring the at least one small-coverage base station to operate on a given channel;
detecting usage information of the at least one small-coverage base station on the given channel; and
adjusting an overall transmit power of at least one large-coverage base station in the coverage area based at least in part on the usage information.

2. The method of claim 1, wherein the overall transmit power comprises transmit power for all common, control, and data channels.

3. The method of claim 1, wherein the adjusting comprising adjusting at a long-term time scale.

4. The method of claim 1, wherein adjusting comprises increasing the transmit power of the at least one large-coverage base station in response to the usage information being less than a threshold level associated with the given channel.

5. The method of claim 1, wherein adjusting comprises reducing the transmit power of the at least one large-coverage base station, in response to the usage information being greater than a threshold level associated with the given channel.

6. The method of claim 5, further comprising terminating the transmit power of the at least one large-coverage base station.

7. The method of claim 1, wherein adjusting comprises turning off a carrier of the at least one large-coverage base station.

8. The method of claim 7, further comprising assigning the carrier for dedicated use by the at least one small-coverage base station.

9. The method of claim 1, wherein the usage information includes a density of deployed small-coverage base stations in the coverage area.

10. The method of claim 1, wherein the usage information includes a data demand of the wireless communications network.

11. The method of claim 1, wherein the usage information includes a backhaul capacity of a given coverage area of the at least one small-coverage base station.

12. The method of claim 1 further comprising:
switching an operational mode of the at least one small-coverage base station from a closed access mode to an open access or hybrid access mode.

13. The method of claim 12, further comprising increasing the transmit power of the at least one small-coverage base station.

14. The method of claim 1, wherein:
the network entity comprises a home node B (HNB) management system (HMS), an operation, administration and management (OAM) server, or a centralized SON server;
the at least one large-coverage base station comprises a macrocell or a picocell; and
the at least one small-coverage base station comprises a femtocell.

15. The method of claim 1, wherein:
the network entity comprises a home node B (HNB) management system (HMS), an operation, administration and management (OAM) server, or a centralized SON server;
the at least one large-coverage base station comprises a macrocell; and
the at least one small-coverage base station comprises a picocell.

16. An apparatus comprising:
at least one processor configured to: configure at least one small-coverage base station to operate on a given channel; detect usage information of the at least one small-coverage base station on the given channel; and adjust an overall transmit power of at least one large-coverage base station in the coverage area based at least in part on the usage information; and
a memory coupled to the at least one processor for storing data.

17. The apparatus of claim 16, wherein the overall transmit power comprises transmit power for all common, control, and data channels.

18. The apparatus of claim 16, wherein the processor is further configured to adjust at a long-term time scale.

19. The apparatus of claim 16, wherein the at least one processor is further configured to increase the transmit power of the at least one large-coverage base station in response to the usage information being less than a threshold level associated with the given channel.

20. The apparatus of claim 16, wherein the at least one processor is further configured to reduce the transmit power of the at least one large-coverage base station in response to the usage information being greater than a threshold level associated with the given channel.

21. The apparatus of claim 20, wherein the at least one processor is further configured to terminate the transmit power of the at least one large-coverage base station.

22. The apparatus of claim 16, wherein adjusting comprises turning off a carrier of the at least one large-coverage base station.

23. The apparatus of claim 22, further comprising assigning the carrier for dedicated use by the at least one small-coverage base station.

24. The apparatus of claim 16, wherein the usage information includes a density of deployed small-coverage base stations in the coverage area.

25. The apparatus of claim 16, wherein the usage information includes a data demand of the wireless communications network.

26. The apparatus of claim 16, wherein the usage information includes a backhaul capacity of a given coverage area of the at least one small-coverage base station.

27. The apparatus of claim 16, wherein the at least one processor is further configured to:
switch an operational mode of the at least one small-coverage base station from a closed access mode to an open access or hybrid access mode.

28. The apparatus of claim 27, wherein the at least one processor is further configured to increase the transmit power of the at least one small-coverage base station.

29. The apparatus of claim 16, wherein:
the apparatus comprises a home node B (HNB) management system (HMS), an operation, administration and management (OAM) server, or a centralized SON server; and
the at least one small-coverage base station comprises a femtocell or a picocell.

30. An apparatus for deploying at least one small-coverage base station in a coverage area, the apparatus comprising:
means for configuring the at least one small-coverage base station to operate on a given channel;
means for detecting usage information of the at least one small-coverage base station on the given channel; and
means for adjusting a transmit power of at least one large-coverage base station in the coverage area based at least in part on the usage information.

31. The apparatus of claim 30, wherein the overall transmit power comprises transmit power for all common, control, and data channels.

32. The apparatus of claim 30, wherein the means for the adjusting is further configured for adjusting at a long-term time scale.

33. The apparatus of claim 30, wherein the means for adjusting is further configured for increasing the transmit power of the at least one large-coverage base station in response to the usage information being less than a threshold level associated with the given channel.

34. The apparatus of claim 30, wherein the means for adjusting is further configured for reducing the transmit power of the at least one large-coverage base station in response to the usage information being greater than a threshold level associated with the given channel.

35. The apparatus of claim 34, wherein the means for adjusting is further configured to terminate the transmit power of the at least one large-coverage base station.

36. The apparatus of claim 30, wherein means for adjusting is further configured for turning off a carrier of the at least one large-coverage base station.

37. The apparatus of claim 36, further comprising means for assigning the carrier for dedicated use by the at least one small-coverage base station.

38. The apparatus of claim 30, wherein the usage information includes a density of deployed small-coverage base stations in the coverage area.

39. The apparatus of claim 30, wherein the usage information includes a data demand of the wireless communications network.

40. The apparatus of claim 30, wherein the usage information includes a backhaul capacity of a given coverage area of the at least one small-coverage base station.

41. The apparatus of claim 30, further comprising means for switching an operational mode of the at least one small-coverage base station from a closed access mode to an open access or hybrid access mode.

42. The apparatus of claim 41, wherein the means for adjusting is further configured for increasing the transmit power of the at least one small-coverage base station.

43. The apparatus of claim 30, wherein:
the apparatus comprises a home node B (HNB) management system (HMS), an operation, administration and management (OAM) server, or a centralized SON server; and
the at least one small-coverage base station comprises a femtocell or a picocell.

44. A computer program product, comprising:
a computer-readable medium comprising code for causing a computer to:
configure at least one small-coverage base station in a coverage area to operate on a given channel;
detect usage information of the at least one small-coverage base station on the given channel; and
adjust a transmit power of at least one large-coverage base station in the coverage area based at least in part on the usage information.

45. The computer program product of claim 44, wherein the overall transmit power comprises transmit power for all common, control, and data channels.

46. The computer program product of claim 44, wherein the adjusting comprising adjusting at a long-term time scale.

47. The computer program product of claim 44, wherein adjusting comprises increasing the transmit power of the at least one large-coverage base station, in response to the usage information being less than a threshold level associated with the given channel.

48. The computer program product of claim 44, wherein adjusting comprises reducing the transmit power of the at least one large-coverage base station, in response to the usage information being greater than a threshold level associated with the given channel.

49. The computer program product of claim 48, further comprising terminating the transmit power of the at least one large-coverage base station.

50. The computer program product of claim 44, wherein adjusting comprises turning off a carrier of the at least one large-coverage base station.

51. The computer program product of claim 50, further comprising assigning the carrier for dedicated use by the at least one small-coverage base station.

52. A method operable by a network entity in a wireless communication network, the method comprising:
configuring at least one large-coverage base station to use time or frequency resources of the network;
configuring at least one small-coverage base station to use a first subset of the time or frequency resources; and
in response to a density of small-coverage base stations in a given coverage area increasing to a defined threshold level, configuring the at least one large-coverage base station to use a second subset of the time or frequency resources, wherein the second subset includes time or frequency resources that are orthogonal to the time or frequency resources in the first subset.

53. The method of claim 52, further comprising configuring another at least one small-coverage base station to use a third subset of the time or frequency resources, wherein the third subset is orthogonal to the first and second subsets of time or frequency resources.

54. An apparatus in a wireless communication network, the apparatus comprising:
at least one processor configured to: configure at least one large-coverage base station to use time or frequency resources; configure at least one small-coverage base station to use a first subset of the time or frequency resources; and, in response to a density of small-coverage base stations in a given coverage area increasing to a defined threshold level, configure the at least one large-coverage base station to use a second subset of the time or frequency resources, wherein the second subset includes time or frequency resources that are orthogonal to the time or frequency resources in the first subset; and
a memory coupled to the at least one processor for storing data.

55. An apparatus in a wireless communication network, the apparatus comprising:
means for configuring at least one large-coverage base station to use time or frequency resources;
means for configuring at least one small-coverage base station to use a first subset of the time or frequency resources; and
means for configuring the at least one large-coverage base station to use a second subset of the time or frequency resources in response to a density of small-coverage base stations in a given coverage area increasing to a defined threshold level, the second subset includes time or frequency resources that are orthogonal to the time or frequency resources in the first subset.

56. A computer program product, comprising:
a computer-readable medium comprising code for causing at least one computer to:
configure at least one large-coverage base station to use time or frequency resources of the network;
configure at least one small-coverage base station to use a first subset of the time or frequency resources; and
in response to a density of small-coverage base stations in a given coverage area increasing to a defined threshold level, configure the at least one large-coverage base station to use a second subset of the time or frequency resources, wherein the second subset includes time or frequency resources that are orthogonal to time or frequency resources in the first subset.
